(19) United States
(12) Patent Application Publication
(10) Pub. No.: US 2011/0065194 A1
(43) Pub. Date: Mar. 17, 2011

(54) Microfluidic detection device and method for detecting molecules using the same

(75) Inventors: Ren-Kun Liang, Sanchong City (TW); Yu-Chia Tsao, Taipei City (TW); Woo-Hu Tsai, Taipei City (TW)

(73) Assignee: Forward Electronics Co., Ltd., Taipei City (TW)

(21) Appl. No.: 12/662,567

(22) Filed: Apr. 23, 2010

(30) Foreign Application Priority Data
Sep. 11, 2009 (TW) 098130658

(51) Int. Cl. G01N 21/00

(52) U.S. Cl. 436/71; 422/69; 436/169; 436/94; 436/86

(57) ABSTRACT

A microfluidic detection device is disclosed, which includes a porous membrane, a wicking pad, and an optical sensor. The porous membrane has a first end and an opposite second end, and the first end has a sample-loading area for receiving sample molecules. The wicking pad is connected with the second end of the porous membrane to move the sample molecules from the sample-loading area of the porous membrane to the second end thereof. The optical sensor has a detection zone which faces the porous membrane for sensing the sample molecules. Also, a method for detecting molecules is disclosed, which uses the aforesaid device. The method and the device can achieve the purpose of real-time detection and fast-screening for molecules.

### BACKGROUND OF THE INVENTION

1. Field of the Invention

The present invention relates to a microfluidic detection device and a method for detecting molecules using the same, more particularly, to a microfluidic detection device where optical sensors and porous membranes are combined and a method for detecting molecules using the same.

2. Description of Related Art

In most microfluidic biodetection devices developed currently, sample solutions are mobilized in close loop by an external pump so as to achieve transportation, mixture, detection, etc. In various microfluidic biodetection devices, different geometrical microfluidics or driving forces are used to control the mobility, mixture, or reaction of the sample solutions. Researchers have developed microfluidic channels which simulate physical environment of cells in order to detect the interaction between cells, biomolecules, or tested drugs and cells. However, such developed devices have high costs and usually require to be incorporated in a particular system. In addition, the system is bulky and requires long detection time.

In recent years, as the technique of surface plasmon resonance (SPR) has developed to maturity, this technique is extensively applied to identification of chemical or biological molecule characteristics or detection of interaction between two molecules. The conventional SPR technique has benefits such as high sensitivity, real-time monitoring of dynamic variation, and biodetection without using markers. Optical fibers based on the same concept as SPR are also applied comprehensively owing to their compactness and low costs. Moreover, as the biodetection technique develops to further maturity day by day, many biodetection systems are widely utilized in various technical fields. In the very recent past, since certain influenza viruses have spread vigorously, virus detection and epidemic prevention have become major issues for global health. Hence, there is an urgent need to develop a real-time and prompt screening system.

It has been reported that an optical sensor of SPR and a microfluidic device of geometrical channels were combined for accelerating immunodetection of proteins and achieving accurate biomolecule detection. However, in such sensitive biodetection systems, there is significant difficulty in designing microfluidics designed and an external pump is required. Hence, it is not applicable that real-time detection is carried out in the biodetection system. If there are attempts to improve and miniaturize current microfluidic biodetection device, bottlenecks of the current techniques and the difficulty in controlling the device consistence will be encountered.

Therefore, it is desirable to develop a compact microfluidic biodetection device with low costs, simple operation, and use convenience. In such a device, a geometrical design of microfluidic channels and the external pump both are not required for the mobility of the sample solution, but real-time and prompt detection of biomolecules still can be achieved.

### SUMMARY OF THE INVENTION

In view of the abovementioned, the present invention provides a microfluidic detection device comprising: a porous membrane having a first end and an opposite second end, wherein the first end has a sample-loading area for receiving sample molecules; a wicking pad connected with the second end of the porous membrane to move the sample molecules from the sample-loading area of the porous membrane to the second end thereof; and an optical sensor having a detection zone which faces the porous membrane for sensing the sample molecules.

The present invention also provides a method for detecting molecules comprising the following steps: providing the microfluidic detection device of the present invention; loading sample molecules into the sample-loading area of the porous membrane to move the sample molecules from the sample-loading area of the porous membrane to the second end thereof; and identifying the sample molecules according to signals output from the microfluidic detection device.

In the present invention, the wicking pad is used to guide the sample molecules in the porous membrane. In the wicking pad, numerous micropores form microfluidics for movement of the sample molecules. Under the guidance of the wicking pad, the sample molecules move from the first end to the second end of the porous membrane through capillary action. Meanwhile, the optical sensor can detect the sample molecules in the microfluidic by SPR. Hence, the concentration and the species of the sample molecules can be real-timely identified.

In the aforesaid microfluidic detection device and method for detecting molecules, the optical fiber sensor can be crossed by the porous membrane, and the porous membrane can be a nitrocellulose membrane. Since nitrocellulose is considerably stable to biomolecules such as proteins, nucleic acids and so on, it is very suitable for biomolecule detection.

In the microfluidic detection device and method mentioned above, the optical sensor is not limited in a particular type, and, for example, it can be an optical fiber sensor. Besides, the sample molecules are also not particularly limited, and for example, they can be biomolecules such as nucleic acids, saccharides, proteins, lipids, phospholipids, glycolipids, sterol, vitamins, hormones, nucleotides, and peptides, as well as non-biomolecules such as chemicals and drugs.

The foregoing microfluidic detection device can further comprise a bottom plate having an opening, a first surface, and an opposite second surface, wherein the wicking pad and the porous membrane are arranged on the first surface of the bottom plate, and the sample-loading area of the porous membrane is arranged correspondingly to the opening of the bottom plate. In addition, the microfluidic detection device can further comprise a sample pad arranged on the second surface of the bottom plate, and connected with the sample-loading area of the porous membrane through the opening of the bottom plate.

The present invention uses the porous membrane (being thermostable, highly permeable, considerably safe, and suitable for biomolecule analyses) together with the wicking pad (functioning as microfluidic channels) to transport the biomolecules through capillary action. Because the cited porous membrane is suitable for biomolecule analyses, the wicking pad is easily available and cheap, and the design of the microfluidics is easy and does not need any closed loop, the microfluidic detection device of the present invention is appropriate for any kind of biomolecule detections.

Other objects, advantages, and novel features of the invention will become more apparent from the following detailed description when taken in conjunction with the accompanying drawings.

### BRIEF DESCRIPTION OF THE DRAWINGS

FIG. 1a is a perspective view of a microfluidic detection device in Example 1 of the present invention;

FIG. 1b is a perspective view of a microfluidic detection device in Example 2 of the present invention;

FIG. 2 shows a spectrum in a mobility test of Test Example 1 of the present invention;

FIG. 3 shows a spectrum in a miscibility test of Test Example 2 of the present invention;

FIG. 4 shows a spectrum in a test of residual property in Test Example 3 of the present invention;

FIG. 5 shows a spectrum of biotin-BSA test in Test Example 4 of the present invention, where FIGS. 5a and 5b respectively show that 0.5 and 7.5 μg/mL biotin-BSA are detected in a device of Comparative Example 1, and FIGS. 5a and 5b respectively show that 0.5 and 7.5 μg/mL biotin-BSA are detected in the device of Example 1;

FIG. 6 shows a curve of concentration vs. dip shift in Test Example 4 of the present invention; and

FIG. 7 is a perspective view of the device in Comparative Example 1 of the present invention.

### DETAILED DESCRIPTION OF THE PREFERRED EMBODIMENT

In the detection device of the present invention, the inventor had used the nitrocellulose membrane as the porous membrane and then tested the nitrocellulose membrane with yellow and blue solutions in sequence. The inventor observed that the yellow solution promptly moved from one side of the membrane to the other side thereof. In other words, the yellow solution moved towards the wicking pad through the capillary action. Subsequently, after the blue solution was dropped into the membrane, it could be observed that the blue solution also was quickly absorbed and not only promptly moved toward the wicking pad, but also pushed the yellow solution forward. Accordingly, the microfluidics of the porous membrane can guide the solution flowing in one direction and the wicking pad can draw the solution.

Therefore, in the present invention, the side-polished optical fiber sensor serves as the optical sensor, and is combined with the porous membrane and the wicking pad to function as a microfluidic detection device through the capillary action and the surface tension. Simultaneously, the detection of the sample molecules can be conveniently and stably performed. In addition, the detection device of the present invention has a simple design and low costs, and thus it can be suitably applied in the buildup of the microbiodetection system.

Because of the specific embodiments illustrating the practice of the present invention, one skilled in the art can easily understand other advantages and efficiency of the present invention through the content disclosed therein. The present invention can also be practiced or applied by other variant embodiments. Many other possible modifications and variations of any detail in the present specification based on different outlooks and applications can be made without departing from the spirit of the invention.

The drawings of the embodiments in the present invention are all simplified charts or views, and only reveal elements relative to the present invention. The elements revealed in the drawings are not necessarily aspects of the practice, and quantity and shape thereof are optionally designed. Further, the design aspect of the elements can be more complex.

### Example 1

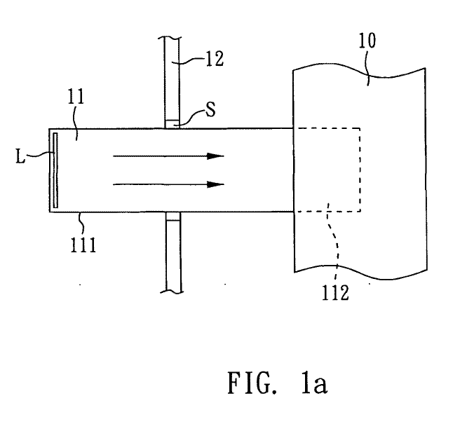

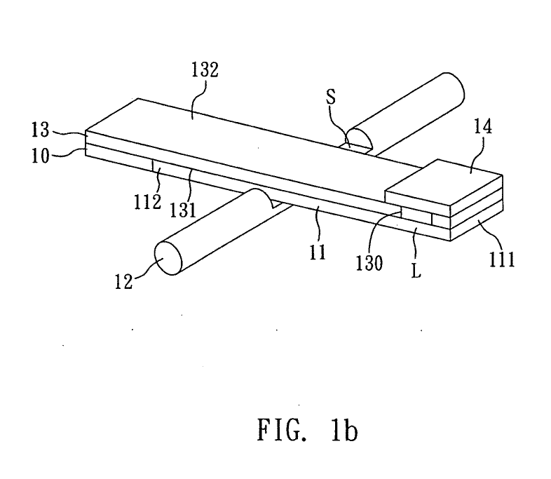

FIG. 1a shows a perspective view of a microfluidic detection device of the present invention. The detection device includes a wicking pad 10, a porous membrane 11, and an optical sensor 12. In the detection device; the porous membrane 11 has multiple pores, and these pores can constitute microfluidic channels for movement of the sample molecules. Hence, the porous membrane 11 can be an analytical membrane. In addition, the porous membrane 11 has first end 111 and an opposite second end 112. The first end 111 has a sample-loading area L for receiving sample molecules. In the present invention, a nitrocellulose membrane is used as the porous membrane 11. Nitrocellulose generally has good chemical stability and thus it is suitable to serve as microfluidic channels for biomolecules such as protein and nucleic acid.

The wicking pad 10 overlaps the second end 112 of the porous membrane 11. The sample molecules in the sample-loading area L at the first end 111 of the porous membrane 11 are guided by the wicking pad 10 to move towards the second end 112 of the porous membrane 11 through the capillary action.

The optical sensor 12 has a detection zone S that faces the porous membrane 11 in order to detect the sample molecules moving in the porous membrane 11. In the present invention, an optical fiber sensor is used as the optical sensor 12. As shown in FIG. 1a, the optical sensor 12 is arranged underneath the porous membrane 11 and is crossed thereby. However, one skilled in the art of the present invention can understand that the aforesaid arrangement is not the only one that can be applied, and the arrangement can be changed if necessary.

### Example 2

FIG. 1b is a perspective view of another microfluidic detection device of the present invention. The detection device of the present example includes a wicking pad 10, a porous membrane 11, an optical sensor 12, a bottom plate 13, and a sample pad 14.

The porous membrane 11 has first end 111 and an opposite second end 112. The first end 111 has a sample-loading area L for receiving sample molecules. In the present invention, a nitrocellulose membrane is used as the porous membrane 11. The second end 112 is connected with the wicking pad 10.

The bottom plate 30 has an opening 130, a first surface 131, and an opposite second surface 132. The wicking pad 10 and the porous membrane 11 are arranged on the first surface 131 of the bottom plate 13, and the sample-loading area L of the porous membrane 11 is arranged correspondingly to the opening 130 of the bottom plate 13.

The optical sensor 12 has a detection zone S that faces the porous membrane 11 in order to detect the sample molecules moving in the porous membrane 11. The optical sensor 12 is arranged underneath the porous membrane 11 and is crossed thereby.

The sample pad 14 is arranged on the second surface 132 of the bottom plate 13. The sample pad 14 penetrates through the opening 130 of the bottom plate 13, and then is connected with the sample-loading area L of the porous membrane 11.

### Comparative Example 1

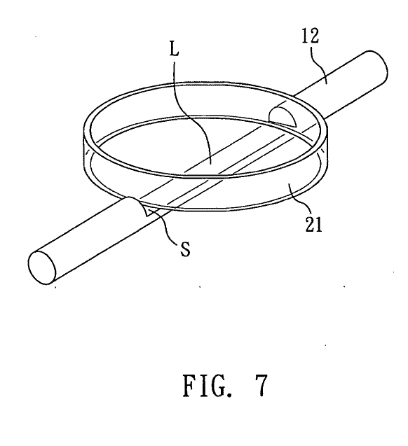

FIG. 7 shows a perspective view of a detection device with SPR optical sensors. The detection device has a transparent glass dish 21 and an optical sensor. The optical sensor 12 is arranged underneath the glass dish 21. The glass dish 21 has a sample-loading area L. The optical sensor 12 has a detection zone S that faces the sample-loading area L of the glass dish 21. When the sample molecules are received in the sample-loading area L of the glass dish 21, the detection zone S of the optical sensor 12 can detect the sample molecules.

### Test Example 1

### Mobility Test

The present test is to check whether the sample molecules move in the porous membrane 11.

In the present test, the detection device of Example 1 is scanned per two seconds with a spectrometer. Deionized water is dropped in the sample-loading area L until the output signal becomes stable. Then, alcohol is gradually dropped into the sample-loading area L. Since the microfluidics channels are constituted in the porous membrane 11 for movement of liquid, the loaded alcohol pushes the deionized water forward to the wicking pad 10 until the alcohol replaces the deionized water totally in the microfluidic channels and then becomes a target detected by the optical sensor 12.

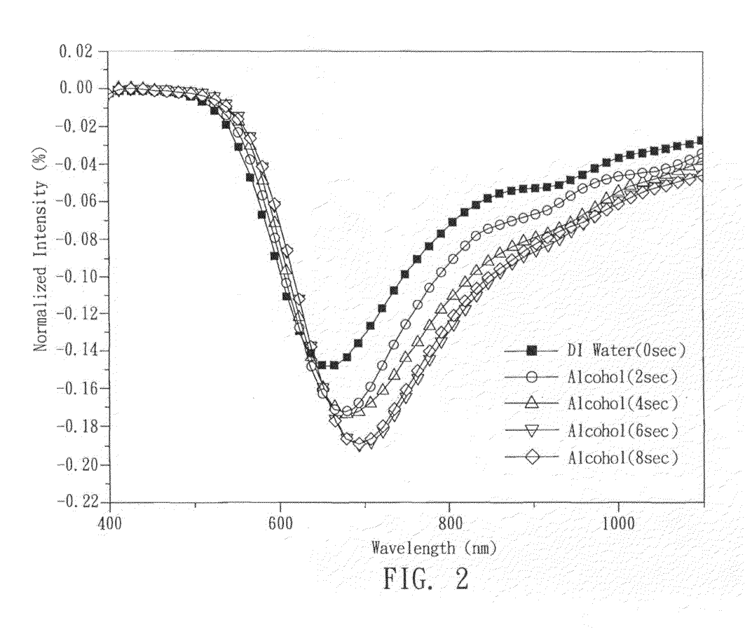

The result is shown in FIG. 2, in which 0 second exhibits the spectrum of the water. As the alcohol is dropped (2 to 8 seconds), the signal gradually shifts right. In other words, the dip shift gradually increases. The spectra of 6 and 8 seconds show that the optical sensor has detected pure alcohol without the deionized water. Accordingly, it can be seen that the sample molecules have good mobility in the porous membrane.

### Test Example 2

### Miscibility Test

The present test is to check whether mixture of the sample molecules occurs in the porous membrane 11.

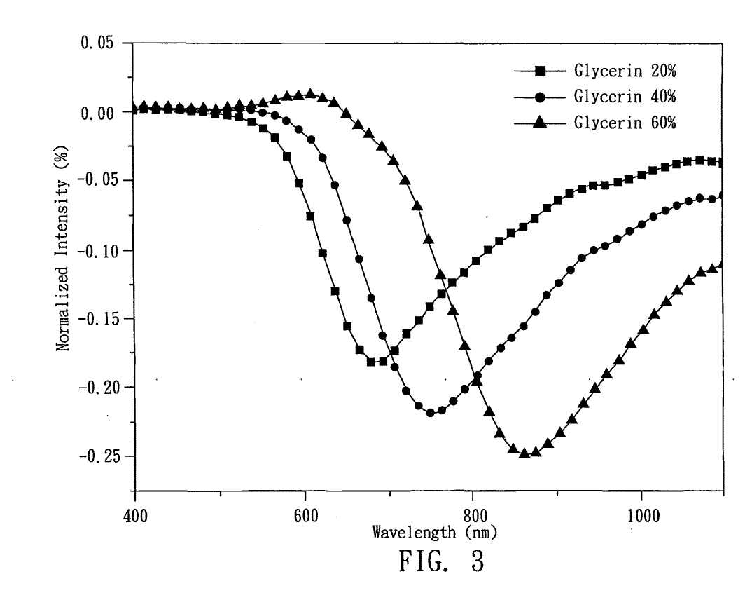

In the detection device of Example 1, 20%, 40%, and 60% glycerin aqueous solution is in order dropped into the sample-loading area L. The result is shown in FIG. 3. The spectra in FIG. 3 show three clear absorbed signals. This indicates mixture of difference samples does not occur when the different sample solutions are detected in the detection device of the present invention. Besides, as the concentration of the glycerin increases, the dip shift also gradually increases. It can be understood that the detection device of the present invention is used to detect not only different molecules but also different concentrations of one molecule.

### Test Example 3

### Residual Property Test

The present test is to check whether the sample molecules remain in the porous membrane 11.

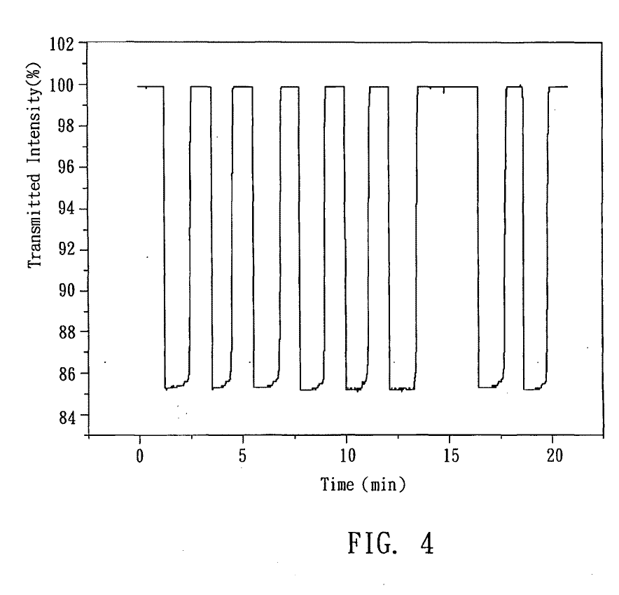

In the detection device of Example 1, deionized water is dropped into the sample-loading area L for 1 minute. Then, after several minutes, deionized water is dropped again. In the same manner mentioned above, the steps of loading and then waiting are carried out repeatedly. The result is shown in FIG. 4. The spectra in FIG. 4 show clear signals of the deionized water, and two signals between two loadings can be definitely distinguished. In addition, occurrence of the signals accords with the time points of adding the deionized water, and no occurrence of the signals also accords with the time points without adding the deionized water. This means the sample molecules do not remain in the detection device of the present invention.

### Test Example 4

### Biotin-Bovine Serum Albumin (Biotin-BSA) Test

The present test is to check whether the detection device of the present invention can be used to detect biomolecules with a low concentration.

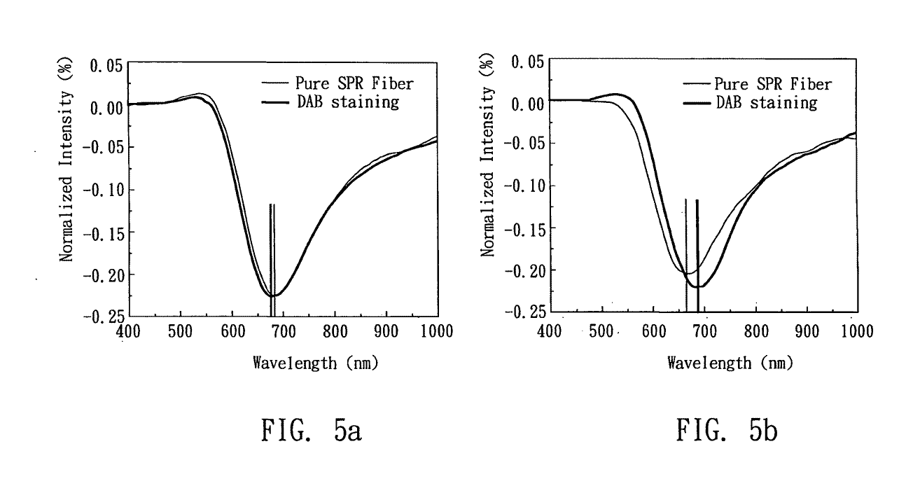

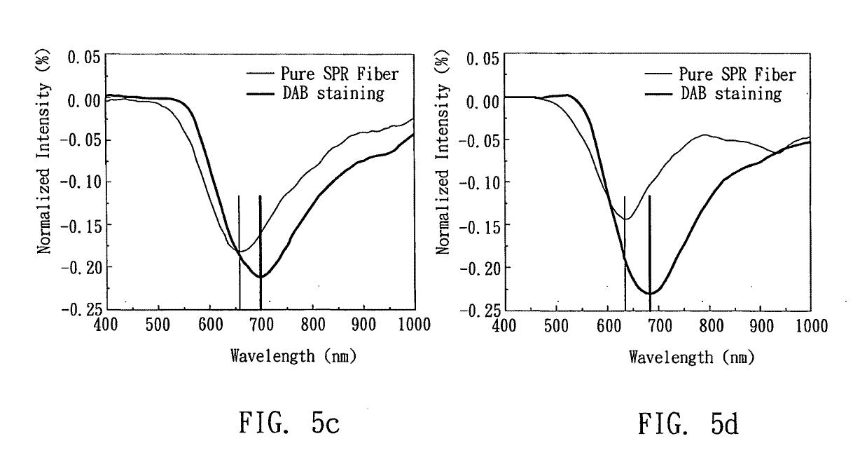

In the detection devices of Example 1 and Comparative Example 1, 0.5 and 7.5 μg/mL biotin-BSA are detected. The result is shown in FIG. 5, in which FIGS. 5a and 5b exhibit the respective results of detecting 0.5 and 7.5 μg/mL biotin-BSA in the detection device of Comparative Example 1, and FIGS. 5c and 5d exhibit the respective results of detecting 0.5 and 7.5 μg/mL biotin-BSA in the detection device of Example 1.

In the figures, the curves of “Pure SPR fiber” represent the spectra of the biotin-BSA solution that is directly dropped into the sample-loading area L of the detection devices of Example 1 and Comparative Example 1.

In the figures, the curves of “DAB staining” represent the spectra of the optical sensors 12 respectively in the detection devices of Example 1 and Comparative Example 1 which are modified by the following steps. First, the surface of the optical sensor is treated with 11-mercaptoundecanoic acid (MUA) to have carboxyl. Then, the carboxyl is activated by 1-Ethyl-3-(3-dimethylaminopropyl)carbodiimide/N-hydroxysuccinimide (EDC/NHS) to bind to the biotin-BSA. A blocking buffer is used to block unbounded biotin-BSA. Streptavidin-horseradish peroxidase (HRP) is added to bind to the biotin-BSA. Finally, 3,3′-Diaminobenzidine (DAB) or 3,3′,5,5′-tetramethylbenzidine (TMB) serving as a color reagent is loaded in the sample-loading area L, and then a plurality of precipitates appears as HRP uses the color reagent to carry out the catalysis. Hence, the signal of the reaction can be amplified.

As shown in FIGS. 5c and 5d, dip shifts occur in both spectra of the detection devices of Example 1 and Comparative Example 1 after the signals are amplified. Compared with low concentration of biotin-BSA, the spectra output by the detection devices demonstrates high concentration thereof can cause larger dip shift after the signal-amplification reaction. Likewise, compared with the detection device of Comparative Example 1, that of Example 1 can demonstrate larger dip shift after the signal-amplification reaction. This means the detection device of Example 1 is more sensitive than that of Comparative Example 1.

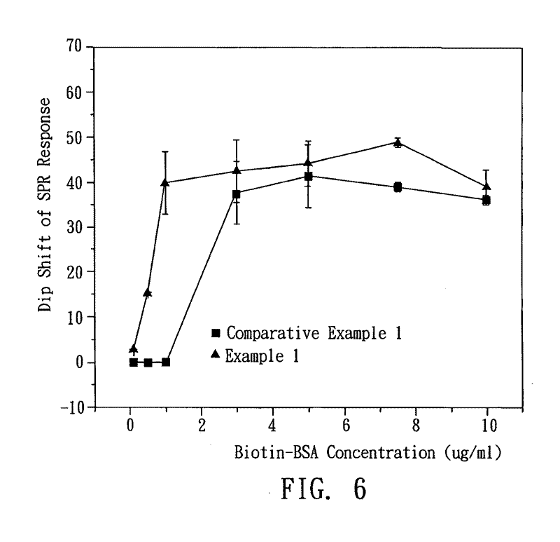

FIG. 6 shows dip shift of SPR response of biotin-BSA with different concentrations detected by the detection devices of Example 1 and Comparative Example 1. As shown in FIG. 6, the SPR response of the detection device of Example 1 is larger than that of Comparative Example 1. This means the detection device of Example 1 is relatively suitable for detection of biomolecules with a low concentration.

In accordance with the abovementioned tests, the structure of the porous membrane combined with the wicking pad can cause capillary action and the pores of the porous membrane can constitute microfluidic channels for mobilization of the sample molecules. Accordingly, such structure is a simple design and conveniently operated. Besides, referring to detection of deionized water, alcohol, and glycerin with different concentrations, the result output from the detection device of the present invention can have better repeatability and stability than that output from a conventional optical fiber detection device. It is also successfully evidenced that biotin-BSA detection can improve the sensitivity of the detection device and the sample molecules or reagents do not remain during detection in the detection device.

The present invention uses the side-polished optical fiber sensor as the optical sensor of the detection device, and also uses nitrocellulose membrane as the porous membrane. Accordingly, through the guiding of the wicking pad, the sample molecules in the porous membrane can mobilize in one direction, but do not mix with the former sample molecules and also do not remain in the detection device of the present invention. Furthermore, the detection device of the present invention is suitable for detection of biomolecules with a low concentration. In conclusion, application of the detection device of the present invention can significantly promote the convenience and feasibility of the biological detection system in real-time monitoring and fast screening.

Although the present invention has been explained in relation to its preferred embodiment, it is to be understood that many other possible modifications and variations can be made without departing from the scope of the invention as hereinafter claimed.

What is claimed is:

1. A microfluidic detection device comprising:
a porous membrane having a first end and an opposite second end, wherein the first end has a sample-loading area for receiving sample molecules;
a wicking pad connected with the second end of the porous membrane to move the sample molecules from the sample-loading area of the porous membrane to the second end thereof; and
an optical sensor having a detection zone which faces the porous membrane for sensing the sample molecules.

2. The microfluidic detection device as claimed in claim 1, wherein the porous membrane is a nitrocellulose membrane.

3. The microfluidic detection device as claimed in claim 1, wherein the optical sensor is an optical fiber sensor.

4. The microfluidic detection device as claimed in claim 3, wherein the optical fiber sensor is crossed by the porous membrane.

5. The microfluidic detection device as claimed in claim 1, wherein the sample molecules are selected from the group consisting of nucleic acids, saccharides, proteins, lipids, phospholipids, glycolipids, sterol, vitamins, hormones, nucleotides, and peptides.

6. The microfluidic detection device as claimed in claim 1, further comprising: a bottom plate having an opening, a first surface, and an opposite second surface, wherein the wicking pad and the porous membrane are arranged on the first surface of the bottom plate, and the sample-loading area of the porous membrane is arranged correspondingly to the opening of the bottom plate.

7. The microfluidic detection device as claimed in claim 6, further comprising: a sample pad arranged on the second surface of the bottom plate, and connected with the sample-loading area of the porous membrane through the opening of the bottom plate.

8. A method for detecting molecules comprising the following steps:
providing a microfluidic detection device comprising: a porous membrane having a first end and an opposite second end, wherein the first end has a sample-loading area for receiving sample molecules; a wicking pad connected with the second end of the porous membrane to move the sample molecules from the sample-loading area of the porous membrane to the second end thereof; and an optical sensor having a detection zone which faces the porous membrane for sensing the sample molecules;
loading sample molecules into the sample-loading area of the porous membrane to move the sample molecules from the sample-loading area of the porous membrane to the second end thereof; and
identifying the sample molecules according to signals output from the microfluidic detection device.

9. The method as claimed in claim 8, wherein the sample molecules are selected from the group consisting of nucleic acids, saccharides, proteins, lipids, phospholipids, glycolipids, sterol, vitamins, hormones, nucleotides, and peptides.

10. The method as claimed in claim 8, wherein the porous membrane is a nitrocellulose membrane.

11. The method as claimed in claim 8, wherein the optical sensor is an optical fiber sensor.

12. The method as claimed in claim 11, wherein the optical fiber sensor is crossed by the porous membrane.

13. The method as claimed in claim 8, wherein the microfluidic detection device further comprises: a bottom plate having an opening, a first surface, and an opposite second surface, wherein the wicking pad and the porous membrane are arranged on the first surface of the bottom plate, and the sample-loading area of the porous membrane is arranged correspondingly to the opening of the bottom plate.

14. The method as claimed in claim 13, wherein the microfluidic detection device further comprises: a sample pad arranged on the second surface of the bottom plate, and connected with the sample-loading area of the porous membrane through the opening of the bottom plate.
